(19) United States
(12) Patent Application Publication
(10) Pub. No.: US 2026/0138017 A1
(43) Pub. Date: May 21, 2026

(54) VISUAL CUES INDICATING WHEN A PLAYER DURING A GAMEPLAY OF A VIDEO GAME IS IN ISOLATION MODE OR IS OPEN TO COMMUNICATION

(71) Applicant: Sony Interactive Entertainment Inc., Tokyo (JP)

(72) Inventor: Jeppe Oland, San Mateo, CA (US)

(21) Appl. No.: 18/959,342

(22) Filed: Nov. 25, 2024

Related U.S. Application Data
(60) Provisional application No. 63/721,386, filed on Nov. 15, 2024.

(51) Int. Cl. A63F 13/537

(52) U.S. Cl. CPC A63F 13/537

(57) ABSTRACT

Methods and systems are disclosed for receiving requests from one or more users to interact with a player during gameplay of a video game. Game content generated by applying inputs provided by the player are used to determine the game context and game state, and to determine a level of involvement of the player in the gameplay. Appropriate visual cues are provided to the speakers based on the level of involvement of the player. Additionally, the player is provided with visual cues that provide details of the speakers who are interested in interacting with the player.

### CLAIM OF PRIORITY

The present application claims priority to and the benefit of the commonly owned, provisional patent application, U.S. Ser. No. 63/721,386, entitled “VISUAL CUES INDICATING WHEN A PLAYER DURING A GAMEPLAY OF A VIDEO GAME IS IN ISOLATION MODE OR IS OPEN TO COMMUNICATION,” with filing date of Nov. 15, 2024, which is herein incorporated by reference in its entirety.

### TECHNICAL FIELD

### 1. Field of the Invention

The present disclosure relates to providing visual cues to a user in relation to gameplay of a video game, and more specifically, providing visual cues to a user to indicate a level of involvement of a player currently engaged in gameplay of the video game.

### BACKGROUND OF THE INVENTION

### 2. Description of the Related Art

Video gaming industry has grown in popularity and represents a large percentage of the entertainment market and interactive content generated worldwide. Various types of video games are available for playing. There are single-player video games and multi-player video games. In the case of multi-player video games, the users can play individually against one another or can be part of a team of users playing against at least one other second team. Further, the users of the multi-player video games can be co-located or remotely located from one another. A player can select a video game for game play and provide game inputs used to affect a game state of the video game and to update game content. The updated game content includes game scenes that are returned to client device of the player for rendering. In the case of the multi-player video game, the game inputs of the different players are used to affect the game state and to synchronize the game content generated and returned to the client devices associated with the different players.

While the player is engaged in gameplay, one or more users may wish to interact with the player. The users who want to engage in the interaction with the player may be users who are in the physical world of the player or users who are in the digital world and following the player online. However, the player may not want to be disturbed during their gameplay either because they want to follow the flow of the game, or they are currently involved in an intense portion (i.e., intense phase) of the game that needs their full and undivided attention/concentration. In either case, there is no way to alert or inform the users of the player's intention or the game state of the game so that the users do not feel ignored or to inform the users when the player can be interrupted and when they need to be left alone to continue with the gameplay. Even when the player is not actively engaged in providing inputs to the game, the player may not want to be disturbed during the gameplay.

Alternately, as the player is fully engaged in gameplay, the player may not be aware of which users are trying to get their attention or what the users want to say to the player. The users may be real-world users trying to interact with the player (i.e., real-world interruption) or may be a spectator who is following the gameplay of the player (i.e., digital-world interruption or online interruption). The player needs to be made aware of the type of users, the number of users, and the type of interactions that the users are trying to engage in with the player.

It is in this context that embodiments of the invention arise.

### SUMMARY

Implementations of the present disclosure relate to systems and methods for processing the inputs of the player, the game context and game state of the video game that the player is currently engaged in playing, and determine the level of involvement of the player. Based on the level of involvement, a mode of operation of the player in the video game is determined. In accordance to the mode of operation of the player, appropriate visual cues are provided to users that are trying to interrupt the player during the gameplay. In addition to or instead of providing visual cues to the users, the systems and methods can provide visual cues to the player engaged in the gameplay of the video game. The visual cues to the player could include details of the user who is trying to interact with the player (i.e., interrupt the gameplay of the player). The user trying to interrupt the user's gameplay may be a user in the physical world (i.e., a real-world interruption) or may be a spectator following the gameplay of the player online (i.e., a digital-world interruption—trying to interact with the player through interactive applications). In some cases, more than one user maybe trying to interrupt the player during gameplay. In such cases, a list of the users trying to interrupt the player is generated and returned to the client device of the player for rendering. The list of the users may be organized in accordance to the user preferences specified by the player, a type and content of the interaction, etc., and provided to inform to the player that some of the users are trying to interrupt the player's gameplay.

In addition to providing visual cues, when the player is fully engaged in the gameplay of the video game (i.e., has selected an isolation mode of operation) during a time when the user is trying to interact with the player, the user is provided with an option to leave a message to be presented to the player at a time that is convenient for player's consumption. The message may be a verbal interaction of the user that is captured using audio capturing devices, converted to a textual content in a format specified for the player, and forwarded to a client device of the player for rendering. The textual content can be rendered on a user interface alongside the game content. Depending on the severity of the content in the verbal interaction, the rendering of the game content can be paused and the textual content rendered as soon as it is received, or the textual content can be rendered after a delayed start (i.e., after passage of a predefined delay period), or after detecting the player has progressed to a non-intense portion of the game, etc. In some cases, the severity of the content can be used to determine how the textual content is to be formatted and presented and when it is to be presented (e.g., immediately or after some time—i.e., delayed start). In the case where rendering of the game content was paused (i.e., gameplay was paused), after rendering the textual content for a predefined period of time, rendering of the game content can be resumed. In some cases, the textual content generated from the interaction of the user can pertain to game context of the video game. In such cases, a link for accessing a video of a portion of the gameplay to which the textual content pertains can be included with the textual content presented to the user. Depending on the user providing the interaction or the content included in the message, the player can select to view a replay of the portion of the video game in conjunction with the comments (i.e., interactions) provided by the user. The textual portion of the video game can provide some detail on what moves (i.e., type and sequence of inputs) could help in successfully accomplishing a task in the portion, comments on the gameplay of the player, etc. The player can replay the video of the portion and use the textual content to understand what the user is saying about the gameplay.

The systems and methods thus provide a user with visual cues that are indicative of the level of involvement of the player in the video game and the likelihood of the player allowing interruption during gameplay of the video game. Similarly, the player is provided with visual cues that are indicative of the number, identity and other details of users who are trying to interact with the player during gameplay. The player can elect to interact with the user or elect to view the interaction at a current or later time. Based on the option selected by the player, the gameplay of the video game can be paused (e.g., when the message conveys a serious warning) and the interaction with the user initiated, the gameplay of the video game continued (e.g., when the interaction is from an experienced player or a friend who usually provides some tips related to gameplay) and the interaction with the user initiated, or the gameplay is continued (e.g., when the portion of the gameplay is intense) and the interaction of the user is captured and presented at a delayed time, or the interaction is converted to textual format or video format or anime format and presented to the player alongside the gameplay or later (i.e., temporally delayed) so as to allow the player to view the content of the interaction. In the case where the interaction is captured and presented at a later time or converted, the interaction of the user can be a verbal interaction. The conversion of the verbal interaction to textual content can be in a language and/or in a format preferred by the player.

In one implementation, a method is disclosed. The method includes, detecting a speaker attempting to interact with a player currently engaged in gameplay of a video game via a head mounted display (HMD); analyzing inputs provided by the player during gameplay of the video game to determine a level of involvement of the player in the gameplay at a current time; and providing visual cues to the speaker to indicate the level of involvement of the player in the video game at the current time, the visual cues indicative of a likelihood of interruption entertained by the player at the current time of gameplay of the video game.

In another implementation, a method is disclosed. The method includes, detecting a speaker attempting to interact with a player engaged in gameplay of a video game via a head mounted display (HMD) at a current time; applying inputs provided by the player during gameplay of the video game to generate game content, the game content providing information used to determine game context and a game state of the video game at the current time; analyzing the game context and the game state of the video game to determine a level of involvement of the player in the gameplay at a current time; and when the level of involvement of the player indicates that the player is fully immersed in the gameplay, providing visual cues to the player providing details of the speaker attempting to interact with the player during gameplay.

Other aspects of the present disclosure will become apparent from the following detailed description, taken in conjunction with the accompanying drawings, illustrating by way of example the principles of embodiments described in the present disclosure.

### BRIEF DESCRIPTION OF THE DRAWINGS

The disclosure may be better understood by reference to the following description taken in conjunction with the accompanying drawings.

FIG. 1 represents a simplified block diagram of a cloud system that is used to process audio signals received by a user during gameplay of a video game, in accordance with one implementation.

FIG. 2 represents a simplified block diagram of an interaction mode processing engine engaged to process inputs of the player and determine a mode of operation of a player currently playing the video game, in accordance with an alternate implementation.

FIG. 3A identifies a user interface used to present game content and some visual cues to a speaker who is engaged in digital-world interruption during the gameplay of the player.

FIG. 3B identifies an example of visual cues presented to a speaker who is engaged in real-world interruption, in some implementation.

FIGS. 3C-3E illustrate some examples of visual cues provided to a player currently engaged in gameplay of a video game, in response to detecting one or more users trying to interrupt the gameplay of the player, in accordance with some implementations.

FIG. 4 illustrates components of an example system that can be used to process audio signals generated for the user during gameplay of a video game, in accordance with one implementation.

### DETAILED DESCRIPTION

Broadly speaking, implementations of the present disclosure relate to processing inputs provided by a player of a video game to determine a level of involvement of the player in the video game. The player may be accessing the video game for gameplay via a head mounted display (HMD) in order to have a fully immersive gameplay experience. The HMD allows the immersive gameplay experience by transitioning the screen of the HMD to a non-transparent mode so as to block the views to the real-world environment. The inputs are applied to the video game to generate game content, which, in turn, is used to determine the game context and game state of the video game. The inputs provided by the player in a portion of the video game are compared against the inputs required for that portion of the video game to determine the level of involvement of the player in the portion and, in general, the video game. The inputs required for the portion of the video game are obtained by querying game logic and are used to estimate an intensity of gameplay defined for the portion of the video game. The intensity of gameplay defined by the game logic together with the type, sequence, and number of inputs provided by the player in the portion are used to determine a degree of concentration of the player as the player navigates through the portion of the video game. The degree of concentration correlates with the level of involvement of the player in the video game. Based on the level of involvement of the player, a mode of operation of the player can be defined. The aforementioned operations can be performed by an interactions processing engine executing on a server computing device. Alternately, the player can explicitly specify the mode of operation that they desire to engage in during gameplay of the video game. The player can specify the mode of operation in their user profile that is used during game setup, or can specify at a start of gameplay or at any time during gameplay of the video game. The mode of operation determined/specified for the player can be game-specific or user-specific. In some implementations, the mode of operation is defined to be one of immersive or isolation mode and non-immersive or interruption mode.

When a speaker wants to interrupt the player during gameplay, the mode of operation and/or the level of involvement of the player is used to determine the likelihood of the player entertaining interruption as the player is immersed in gameplay via the HMD. In some cases, the speaker is a user wishing to interact with the player and is approaching the player in the physical world as the player is engaged in gameplay. In other cases, the speaker may be an online user who has expressed interest in interrupting the gameplay of the player in order to interact with the player. In either case, visual cues are provided to the speaker to inform the speaker of the player's status and willingness to be interrupted during gameplay. When the mode of operation of the player indicates that the player is in or wishes to be in isolation mode, the visual cues can be provided to the speaker to indicate that the player does not wish to be interrupted. When the mode of operation of the player indicates that the player is in interruption mode, the visual cues are provided to the speaker to indicate that the player is in the interruption mode and entertains interruption.

The speaker may act according to the visual cues provided to them. For instance, the speaker may choose to not interrupt the player and leave the player alone or try to interrupt the player. In the latter case, as the player has indicated to not be interrupted during gameplay, any interruption received during gameplay is captured and processed so that the message provided by the speaker is presented in a format that is defined for the player. The interaction of the speaker may be in the form of a speech or an audio message. The speaker's interaction is captured as an audio message using one or more audio capturing devices, such as microphones of the HMD, etc. The audio message can be converted to textual message and presented to the player when it is acceptable for the player. Alternatively, the audio message may be captured and stored in memory of the HMD for presenting to the player at a time that the player welcomes interruption. For example, the player may be currently engaged in an intense activity or challenge in a portion of the video game (i.e., intense phase of the video game). In such cases, the converted textual message or the stored audio message of the speaker may be presented to the player after conclusion of the intense activity or challenge. The conclusion of the intense activity or challenge can be determined by dynamically analyzing the game context and game state generated during gameplay of the video game in substantial real-time. In another example, the audio message or the converted textual message may be presented to the player after a predefined period of time, wherein the predefined period of time may be specific for the game activity or challenge or specific for the video game. The presentation of the audio message or the textual message, in some implementations, is in addition to providing the visual cues to the speaker.

In alternate implementations, the player may be presented with visual cues providing details of the speaker initiating the interactions with the player. The speaker can engage in a real-world interruption or an online (i.e., digital-world) interruption. In the case of the real-world interruption, the player may be presented with speaker identity, image of the speaker if captured by one or more image capturing devices distributed in the physical world in which the player is present and is interacting with the video game, details of the audio interaction provided by the speaker, etc. The audio interaction can be processed in substantial real-time to determine if the message needs to be rendered immediately or can be presented at a later time to the player.

Thus, the systems and methods provide ways to process the inputs of the player provided during gameplay to determine the level of involvement and provide visual cues to a speaker who is trying to interrupt the gameplay of the player and to the player so that the speaker and the player can make informed decisions on whether to proceed with the interruption. The decision to interrupt the player during gameplay is solely left with the player allowing the player to have an enriching gameplay experience.

With the general understanding of the disclosure, specific implementations of the disclosure will now be described in greater detail with reference to the various figures. It should be noted that various implementations of the present disclosure can be practiced without some or all of the specific details. In other instances, well known process operations have not been described in detail in order not to unnecessarily obscure various embodiments of the present disclosure.

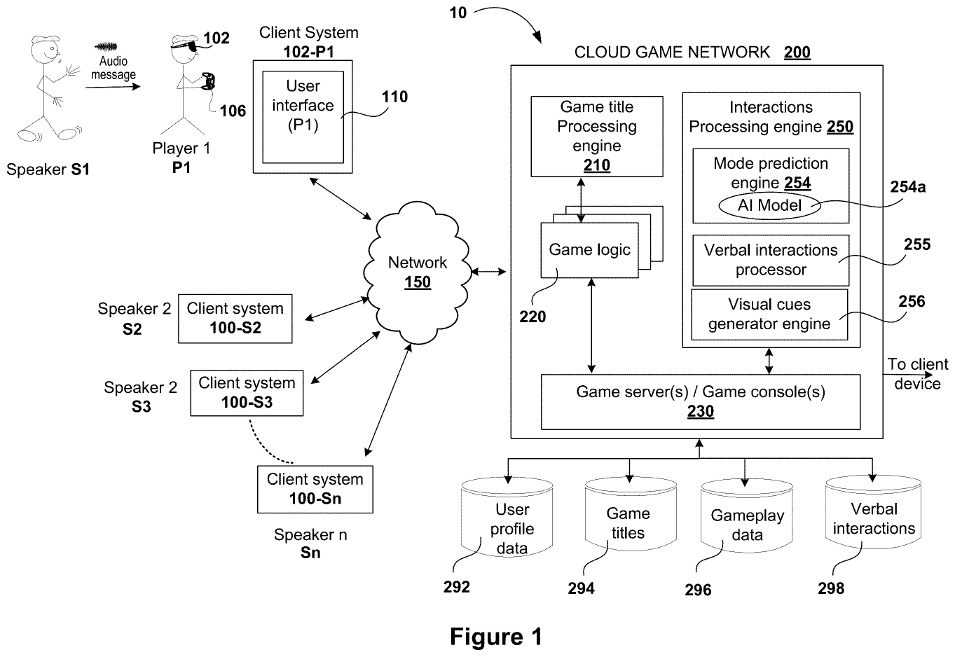

FIG. 1 represents a simplified block diagram of a system 10 that is used for processing game inputs of a player ‘P1’ who has selected a video game for gameplay and interactions of one or more speakers who are interested in interacting with the player P1 as the player P1 is engaged in gameplay, in accordance with some implementations. The video game may be executing remotely on one or more game servers 230 available in a cloud game network 200 and player P1 may be accessing the remotely executing video game for gameplay via a network, such as the Internet, 150 using a client device 102-P1, wherein the client device 102-P1 is a head mounted display (HMD 102) worn on a head of the player P1 and includes a display screen 110 for rendering content, such as game content. The HMD 102 allows the player P1 to have a totally immersive experience by preventing a view to a real-world environment in the vicinity of the player P1 as the player P1 is engaged in gameplay. The HMD includes controls, such as buttons or touch interface, on a side of the HMD to allow the player P1 to provide inputs via the HMD. Alternately, the HMD 102 can be communicatively coupled to a controller 106 held by the player P1, wherein the controller 106 includes controls, such as control buttons and touch interface, etc., for providing inputs to the video game during gameplay.

The video game may be selected using a game title rendered in a user interface on the display screen 110 associated with the client device 102-P1. The selected game title is used by a game title processing engine 210 executing on a server (e.g., game server 230) of the cloud game network 200, to identify the video game by querying a game title datastore 294. Upon identification of the video game, the player P1 is automatically connected to an instance of the identified video game that is executing on one or more game servers or game consoles (or simply referred to as “game servers or servers”) 230, if an instance of the video game is already executing on the server and is available for assigning to the player P1. If the instance of the video game is not available for assigning to the player P1, then a new instance of the video game is instantiated on one or more game servers 230 using the game logic 220 associated with the game title and the new instance is assigned to the player P1 for gameplay.

In response to receiving a request from the player P1, user profile data of the player P1 is retrieved from user profile datastore 292 and the player P1's identity and credentials are validated. The user profile data of the player P1 is used to, (a) verify that the player P1 has authorization to access the video game for gameplay, and (b) set up the video game for gameplay in accordance to the gameplay settings specified for the player P1 in their user profile. Access to the instance of the video game is provided to the player P1 after successful player validation. The player P1 interacts with the video game by providing inputs using one or more inputs devices, such as a controller 106, keyboard (not shown), mouse (not shown), input interface (not shown) of the HMD, etc. The inputs are forwarded to the cloud game network 200 for applying to the video game. Responsive to the inputs from the player, the game server(s) executing the instance of the video game for the player P1 returns game content to the client device for rendering. The game content provides details that can be used to determine game context and a game state of the video game at any given time of the gameplay. The game content is also saved in gameplay datastore 296 that is available at the cloud game network 200.

As the player P1 is engaged in gameplay of the video game via the HMD 102, one or more speakers (i.e., users) may express interest to interact with the player P1 during gameplay. The one or more speakers can include users in the real-world environment and/or the online world (i.e., digital world) environment. For instance, speaker S1 is a user in the real-world environment and is approaching the player P1 in the real-world (i.e., physical world) to engage in verbal interaction with player P1. Alternately or additionally, one or more of speakers (S1, S2, . . . Sn) who are online and watching gameplay of the video game of the player P1 via their respective client devices (100-S2, 100-S3, . . . 100-Sn) may be approaching the player P1 online using one or more online applications or user interfaces to interact with the player P1. In some implementations, the player P1 may have expressly selected an isolation mode when they selected the video game for gameplay. In other implementations, the gameplay in certain portions of the video game may be more intense than certain other portions. When the player P1 is playing the certain portions that are more intense, an interactions processing engine executing on a server and monitoring the inputs of player P1 and the game context of the game may set the mode of operation of the player P1 to be isolation mode so that the player P1 can fully focus in providing inputs to the game. As the player P1 is immersed in gameplay of the video game rendering on the HMD 102, the player P1 may not be aware of what is occurring in the physical world or the digital world. When a request to interact with the player P1 is received, a decision to interrupt the player P1's gameplay may be made either by the player P1 or by analyzing the inputs of the player P1 and game context of the game generated during gameplay to determine the degree of concentration and, thus, a level of involvement of the player P1. In some implementations, the decision to interrupt can be made for the player P1 even when the player P1 had explicitly elected the isolation mode for gameplay.

The analyzing of the inputs and the decision to interrupt can be made by engaging an interactions processing engine 250 available at the cloud game network 200. The interactions processing engine 250 includes logic (e.g., in the form of machine learning algorithm) to weigh the different characteristics of the game and the different inputs provided by the player P1 in different portions of the game to determine the level of involvement of the player P1, and decide whether the player P1 should or can be interrupted. The interactions processing engine 250 retrieves the gameplay data of the player P1 for the current gameplay session stored in the gameplay datastore 296, the user profile data of the player P1 from user profile datastore 292 and analyzes the gameplay and the user profile data to determine a mode of operation of the player P1 in the gameplay of the video game at a current time (i.e., at a time when the speaker interaction/interruption was received/detected).

In some implementations, the player P1 may be in isolation mode indicating that the player P1 is not open for communicating with the one or more speakers. Consequently, visual cues are provided to each of the speakers to indicate the same. During gameplay of the player playing in isolation mode, a decision may be made to interrupt the player P1, wherein the decision may be made by the player P1 or by the interactions processing engine 250 based on the level of involvement of the player in the game. The decision to allow the player P1 to interact can be directed toward a select one of the speakers, when more than one speaker wants to interact with the player P1, or can be directed toward all the speakers. When the decision to interrupt the player P1 is made, the visual cues provided to the select one of the speakers can be dynamically updated to indicate that the player P1 is now open for communicating with the select one of the speakers while the visual cues provided to the other speakers will continue to indicate that the player P1 is not open for communication.

In some implementations, the user profile may include the preferences specified by the player P1 and can include a mode of operation desired by the player P1 when the player engages in gameplay of any video game (if specified by the player P1), type of interruptions that they like to entertain during gameplay, identity of users that are allowed to interrupt the player during gameplay, portions or specific game state of the video game when interruptions can be entertained, type of messaging that the player P1 wishes to receive, etc. The mode of operation specified by the player P1 can be player-specific (i.e., applies to all the video games) or can be video game-specific. For instance, the player P1 can specify that every time the player is involved in gameplay of any video game or a specific video game, the player P1 wishes to be in isolation mode. Additionally, the player P1 may specify that a certain type of interruption (e.g., warning related to player's or other user's safety or an event (e.g., doorbell or phone ringing, dog barking, a child calling) occurring in the physical environment) or a certain one of the users can interrupt the player P1 during gameplay irrespective of the mode of operation of the player P1.

In some implementations, the decision to interrupt may be determined by the interactions processing engine 250 based on a current game state and game context of the video game and the interactions of the player P1 during gameplay at a current time. For instance, the current game state and game context of the video game may indicate that the player P1 is currently engaged in an intense portion of the video game. Additionally, the interactions processing engine 250 further determines that the player P1 is fully engaged in the gameplay based on the inputs and the degree of concentration exhibited by the player P1 when providing the inputs. The interactions processing engine 250 engages a mode prediction engine 254 to create and train an artificial intelligence (AI) model 254a using inputs from the player P1, the game input requirements obtained from game logic of the video game, and the user profile data of the player P1. Output of the AI model 254a is used to determine the level of involvement and, as a result, the mode of operation of the player P1 in the gameplay of the video game.

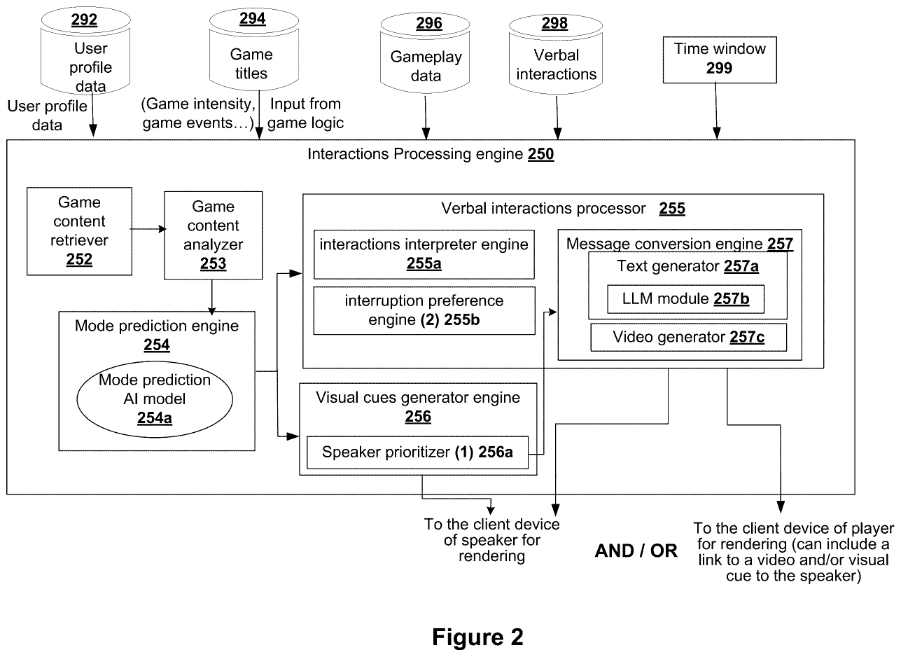

The output of the AI model 254a is used to determine if the player P1 can be interrupted or not interrupted during gameplay. Continued inputs provided by the player P1 during gameplay will result in changes to the game context and game state of the video game, which leads to updates to the mode of operation of the player P1 determined by the interactions processing engine 250. The mode of operation and the level of involvement of the player P1 in the gameplay of the video game is used by the visual cues generator engine 256 to generate visual cues for providing to the speaker(s) trying to interrupt or interact with the player P1 during gameplay. The visual cues generated are indicative of the player P1's interest in getting interrupted and is provided to the speaker(s) so that they can either interact with the player P1 or choose to leave a message for presenting to the player P1 at a later time or leave the player P1 alone to continue with the gameplay uninterrupted. When the speaker leaves a message (e.g., verbal message) for the player P1, the message can be converted from one format to another format (e.g., verbal format to textual, animated or video format) and presented to the player P1 in real-time or after a delay, or the voice message can be presented after a delayed start. The delayed start can be determined based on the game context of the gameplay that the player P1 is involved in at the current time. The textual or animated or video or audio format of the interaction of the speaker(s) can be returned to the client device of the Player P1 for rendering at the appropriate time. Details of the various sub-modules of the interactions processing engine 250 will be described in detail with reference to FIG. 2.

FIG. 2 shows the various sub-modules of the interactions processing engine 250 used to process the inputs of a player P1 provided during gameplay of a video game and the interactions of one or more speakers that are interested in interacting with the player P1 as the player P1 is engaged in gameplay of the video game, in accordance with an implementation. Some of the sub-modules in the interactions processing engine 250 include game content retriever 252, game content analyzer 253, mode prediction engine 254, visual cues generator engine 256 and message conversion engine 257. Of course, the aforementioned sub-modules are provided as examples and fewer or greater number of sub-modules can also be considered. The various sub-modules are used to process the inputs of the player P1 to determine a mode of operation of the player P1, which is then used to inform one or more other users who wish to interact with the player P1, if the player P1 can be interrupted during gameplay. The users (i.e., speakers) can be provided visual cues to indicate the willingness of the player P1 to outside interruption (i.e., interaction, such as verbal interactions, from the users) and provide an option to interrupt the player P1. The option, in some implementation, may be to open up an audio chat channel or user interface to allow the user to interact with the player P1. In addition to providing the users with the visual cues, it may be necessary to provide the player P1 with visual cues as to who all are wishing to interact with the player P1 during gameplay of the game by the player P1. In some implementations, as the player P1 is interacting with the game using the HMD 102, the player P1 may not be aware of anyone wishing to interact with the player P1, especially when the player P1 has selected to be in the isolation mode during gameplay. The visual cues may be provided to the player P1, irrespective of the mode of operation, to let the player P1 know of the users who wish to verbally interact with the player P1.

The game content retriever 252 is used to query the gameplay datastore 296 for the game title of the video game selected by the player P1 for gameplay. As the player P1 is playing the video game and providing inputs, the inputs of the player are stored in the gameplay \datastore 296 and are also applied to the video game by the game logic to determine a game outcome of the video game. The game outcome is used to generate game content that defines game context and game state of the video game at a current time when the inputs were provided. As the player P1 continues to play the video game, the game content and, as a result, the game context and game state keep changing. The game content retriever 252 monitors the gameplay of the video game and when updates to the game content are detected, obtains the game content defining the current game state and provides it as input to the game content analyzer 253.

The game content analyzer 253 queries the game titles datastore 294 to obtain details of the gameplay defined by the game logic for a portion of the video game that corresponds with the received game content, in some implementations. The details of the gameplay for the portion can include the type of activity occurring in the portion, the intensity of the video game defined in the portion, quantity and sequence of inputs required and the speed with which these inputs have to be provided to complete the activity, etc. The game content analyzer 253 uses the details obtained from the game logic and the game content generated for the portion to determine the degree of concentration exhibited by the player, based on the type, sequence, and speed, of the inputs, and the level of involvement of the player P1 in the portion of the game. To determine the degree of concentration and the level of involvement, the game content analyzer 253 analyzes the game context and the game state of the video game included in the game content to determine the intensity of the video game defined in the portion and the type of inputs required for the portion of the video game, and compares that with the type, amount, sequence and speed of inputs provided by the player P1. A level of intensity of the video game defined in the portion of the game is directly proportional to the degree of concentration (i.e., the level of involvement) required from the player P1. The results of the analysis from the game content analyzer 253 and the various inputs retrieved by the game content retriever 252 are provided as inputs to the mode prediction engine 254.

In some implementations, the mode prediction engine engages machine learning algorithm that includes logic to build and train a mode prediction artificial intelligence model (simply referred to as “AI model”) 254a to predict the level of involvement of the player P1 in the gameplay. The AI model 254a is built and trained using the various inputs of the video game, such as gameplay requirements for each portion of the video game specified by the game logic, the inputs of the player P1 in each portion during the current gameplay session of the video game, and the game context and game state of the video game resulting from applying the inputs of the player P1. In some implementations, the AI model 254a is also trained using inputs provided by other players for each portion of the game and the outputs for each portion of the gameplay are identified by comparing the inputs of the player P1 against the inputs of the other players. An output from the trained AI model 254a is identified for the portion of the game that the player P1 is currently playing that corresponds with the type of inputs required, the type of inputs provided by the player P1, the type of inputs provided by other players, the game context and game state of the game resulting from the player P1's inputs as compared to other players inputs. The output for the portion is used to understand the level of involvement and the degree of concentration of the player P1, from which a mode of operation of the player P1 is easily deduced by the mode prediction engine 254.

In some implementations, instead of the mode prediction engine 254 determining the mode of operation of the player P1, the player P1 themself may explicitly specify the mode of operation that they like to follow during gameplay of the game. In such implementations, the mode prediction engine 254 may continue to monitor the activity occurring in the portion and the inputs provided by the player P1 in the portion of the game to determine if the player P1 is actively involved in the gameplay or not, and whether their inputs are comparable to the intensity of the activity and to the inputs provided by other players in the portion. The outputs generated by the AI model for the portion of the video game is identified for the gameplay of the player P1 by taking into consideration the game intensity defined by the different types and sequence of inputs required for the portion, the activity included in each portion, and the input intensity exhibited by the player P1 based on the different types and sequence of inputs provided by the player P1 in the portion of the video game. The game intensity of the game and the input intensity of the player P1 are used to determine a level of involvement exhibited by the player P1 in the gameplay. For example, the game intensity can indicate that the portion of the video game the player P1 is playing at a current time is a very intense portion requiring certain ones of control inputs, special input sequence, certain speed to be followed when providing inputs, etc. The type, sequence, and the number of inputs and speed with which those inputs are provided by the player P1 in the portion are used with the input expectations defined by the game logic and the game state, game context of the portion of the game after applying the inputs of the player P1 to determine the amount of progress made by the player P1 in the portion, which is used to determine if player P1 is fully immersed in the gameplay. When the portion of the game is very intense and the player P1 is shown to be making progress in the portion, then the player P1 is said to be fully immersed (i.e., involved) in the gameplay. Based on this determination, the mode prediction engine 254 may automatically set the mode of operation of the player P1 in the portion to be an immersive or isolation mode. The mode of operation set for the player P1 can determine if the player P1 can be interrupted during gameplay or not. In some implementations, the mode of operation set for the player P1 by the mode prediction engine 254 or by the player P1 can be dynamically changed at any time during gameplay and such change can be done by the interactions processing engine 250 or by the player P1 using control buttons or input surfaces on the controller or the HMD, and such changes are detected, interpreted and used by the interactions processing engine 250 when processing requests from one or more speakers to interrupt the player P1.

In the instance when the player explicitly sets the mode of operation or dynamically changes the mode of operation for gameplay, the mode prediction engine 254 will take that into consideration in determining if the player P1 can be interrupted during gameplay or not. In some implementations, the player P1 may set the mode of operation to an interruption mode for the video game. Even when the player P1 has set to play in the interruption mode, when the mode prediction engine 254 determines that the player P1 is involved in an intense portion of the game, the mode prediction engine 254 may, in some implementations, update the mode of operation of the player P1 to an isolation mode for the portion of the game to allow the player P1 to provide inputs uninterrupted and when the player P1 progresses to a different portion of the game that is less intense, automatically reset the mode of operation of the player P1 to interruption mode. Similarly, the opposite also holds true. For instance, when the player P1 has set to operate in an isolation mode or during gameplay when the mode prediction engine 254 is determining the mode of operation of the player P1, the mode prediction engine 254 may determine that the player P1 is involved in the portion that does not have any or much activity that requires inputs from the player P1 or is not receiving much input from the player P1 (i.e., the intensity of gameplay in the portion of the game is going through a slow phase). Upon detecting the inactivity of the player P1 or the slow phase of gameplay in the portion and other users (e.g., speakers) are requesting to interact with the player P1, the mode prediction engine 254 may set or reset the player P1's mode of operation to interruption mode for the portion and after detecting the player P1's progress to a different portion that requires inputs from the player P1, reset the mode of operation back to the isolation mode. As part of setting/resetting the operation mode of the player P1 to the interruption mode, appropriate visual cues are provided to the one or more speakers to indicate that the player P1 is in an interruption mode and is open for communication and the option to communicate with the player P1 (e.g., providing an audio user interface to communicate with the player P1) may be provided to the one or more speakers.

In some implementations, in addition to providing an option to communicate, one or more characteristics of the gameplay of the game may be dynamically adjusted to allow the speaker to communicate with the player P1. Some of the characteristics of gameplay of the game that can be dynamically adjusted, in some implementations, include speed of the gameplay (e.g., slow the gameplay of the game) and/or volume of the game audio, although adjustment to other characteristics can also be envisioned. The dynamic adjustment to the characteristics in the portion of the game is done to ensure that the player P1 does not miss out on the gameplay of the game while allowing the communication between the speaker and the player P1 to occur. Upon detecting completion of the speaker's interaction with the player P1 or upon detecting the gameplay in the subsequent portion is increasing in intensity, the gameplay characteristics of the game are dynamically reset back to allow the player P1 to continue the gameplay at the original pace or render the game volume to the original level. When the subsequent portion is detected to be intense, the communication with the speaker is automatically cut off or an option to cut off the communication with the speaker is provided to the player P1 leaving the player P1 to decide if they want to continue their interaction with the speaker or continue playing the game. Based on the input from the player P1, the gameplay may be restored to full speed and the player P1 may be set to operate in the isolation mode. Of course, overriding of the mode of operation set by the player P1 may be done if the player P1 allows such overrides, by selecting an option to allow override during the gameplay of the game.

Once the mode of operation of the player P1 is determined (i.e., predicted) in the portion of the game, the interactions processing engine 250 can engage either one or both of a verbal interactions processor 255 and a visual cues generator engine 256 to provide visual cues representing the status of the player P1 to the one or more speakers (S1, S2, . . . Sn) who are expressing interest in interacting with the player P1 and to process the verbal interactions of the one or more speakers. In some implementations, the verbal interactions provided by the one or more speakers are stored in a verbal interactions datastore 298 and retrieved as and when the verbal interactions are to be processed. For example, in the case where the player P1 is in an isolation mode (either by choice of the player P1 or set by the mode prediction engine 254), the interactions processing engine 250 may engage a visual cues generator engine 256 to provide visual cues to the one or more speaker(s) on the status of the player P1. The visual cues generated are indicative of the player P1's willingness to interact with the one or more speaker(s) and can be provided in color-coded—i.e., red to indicate the player is busy, yellow to indicate the player may be somewhat busy but can interact with the one or more speakers at least for a brief period of time, and green to indicate the player is interested in interacting. Alternately, the visual cues can be provided to include different patterns, shapes or forms or in textual, video or graphical user interface (GUI) format or any other format that can be used to indicate the player's status. In some implementations, the visual cues may be provided on an icon of the player P1.

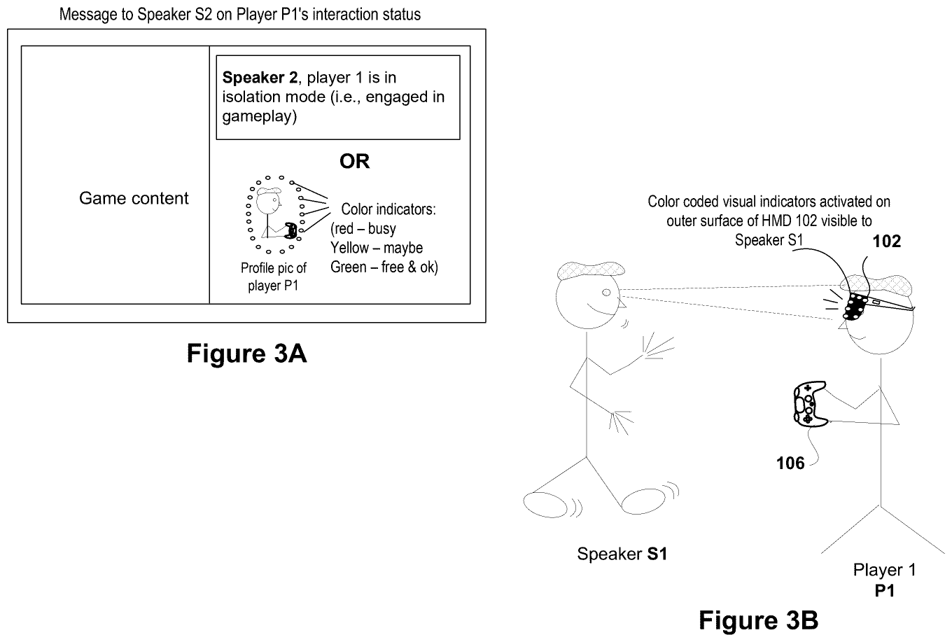

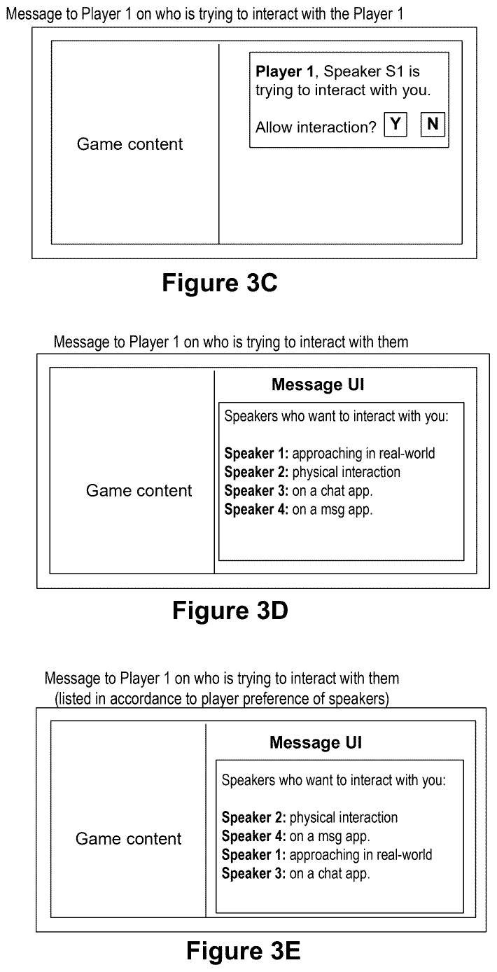

FIG. 3A illustrates some implementation of visual cues provided to the speakers. In one example, the interaction status of the player P1 is rendered in a textual format at a display screen of a client device associated with the speaker (e.g., speaker S2) as shown in the text box on the top right-hand side of the display screen, while the game content is rendered on the left side of the display screen. The speaker is a user who is online and following the gameplay of the player P1. In some implementations, the textual content included in the text box may be presented in a language that is preferred or desired by the speaker S2. In another example, the visual cues are shown as color-coded lights around an icon or an avatar or an image representation of the player P1, as shown in the lower right-hand side of FIG. 3A. The different color codes are used to represent the different interaction status, based on the mode of operation of the player P1. The examples illustrated in FIG. 3A are for providing the visual cues of the player P1's interruption status to an online speaker (e.g., S2, S3 and S4) who is following the gameplay of the player P1.

In some implementations, the speaker may be a real-world person who is approaching the player P1 interacting with the game in the real-world environment. In such implementations, the visual cues may be provided to the speaker by providing it on an outside surface of the HMD 102 of player P1. FIG. 3B illustrates one such implementation where speaker S1 is a real-world person approaching the player P1 as the player P1 is playing the game and providing inputs using the controller 106. As the speaker S1 is in the physical world and does not have any associated client devices for rendering the visual cues, the visual cues generator engine 256 generates and presents the visual cues on the outside surface of the HMD 102 of player P1, so that the speaker S1 approaching player P1 in the physical world can be informed of the interaction status of the player P1. As noted above with reference to FIG. 3A, the visual cues may be in the form of color-coded lights lining the outer boundary of the HMD 102 of the player P1. The visual cues presented on the outside surface of the HMD 102 is not restricted to color-coded lights but can include other types of indicators that can be easily adjusted to indicate the different modes of operation of the player.

In some implementations, the visual cues that are generated are speaker-specific. For instance, a plurality of speakers S2, S3, and S4 may be following the player P1's gameplay online from their respective client devices (100-S2, 100-S3, 100-S) and are expressing interest in interacting with the player P1 during the player P1's gameplay in a portion of the game. The player P1 may be in isolation mode as they are fully immersed in the gameplay in the portion that includes an intense activity, or may be in the isolation mode by choice. In either case, based on the player P1's interruption or interaction mode status (i.e., non-interruption mode), the visual cues generator engine 256 may generate and forward appropriate visual cues for rendering at the respective client devices informing the speakers S2-S4 of the player P1's interruption/interaction status. In some implementations, the visual cues generated for different speakers may be based on player P1's references. For instance, player P1 may prefer or desire to interact with a first speaker and not with other speakers (e.g., second, third, fourth speakers), even when all of these speakers have expressed interest to interact with the player P1 at the same time or at different times when the mode of operation of player P1 is the same. The player P1's preferences may be specified in their user profile or may be based on social relationship of the speakers to player P1 or may be provided by the player P1 before or during gameplay of the video game. In the former case, the visual cues generator engine 256 may query the user profile of player P1 to obtain the player P1's preferences for interacting with different users and use this information to generate the appropriate visual cues to the speakers. In the latter case, the visual cues generator engine 256 may obtain the social relationship by monitoring or querying one or more social media application and use the social relationship of the speakers S2, S3 and S4 to player P1 to generate appropriate visual cues to the speakers. In the above instance, for example, speaker S2 may have a social relationship with the player P1, while the other two speakers S3 and S4 are just spectators following the player P1's gameplay online. Thus, based on the preference or social relationship of the player P1 with speaker S2, the visual cues generator engine 256 may prioritize the different speakers and generate a distinct first visual cue for presenting to speaker S2 that is indicative of player P1's interest in interacting with Speaker S2, and a distinct second visual cue for presenting to distinct speakers S3 and S4 to indicate that the player P1 is busy or is not available for interaction. The distinctly different first and second visual cues are forwarded to the display screen associated with the client devices of the respective speakers for rendering alongside the game content generated from gameplay of player P1.

In some implementations, when two or more speakers expressing interest to interact with player P1 each have social relationship with the player P1, a speaker prioritizer module 256a may be used to prioritize the speakers based on the speaker preferences provided in the user profile or during game set-up or during interactions with other interactive applications based on the level of social relationship enjoyed by the speakers with the player P1. The visual cues generator engine 256 generates the visual cues to the speakers based on the priority of the speakers defined for the player P1. For example, when speakers S2 and S3 both have social relationship with the player P1 and have expressed interest in interacting with the player P1 at the same time, speaker S2 may be prioritized higher due to speaker S2 maintaining a closer social relationship with the player P1 than speaker S3. Consequently, the speaker prioritizer 256a recognizes this distinction in the social relationship and prioritizes the two speakers so that speaker S2 is ranked higher than Speaker S3. The prioritization of the speakers can be done in substantial real-time as and when speakers are requesting to interact with the player P1 when the player P1 is engaged in gameplay of the game. The visual cues generator engine 256 uses the priorities of the speakers and generates and presents distinct visual cues to each of the speakers in accordance to the player P1's willingness to communicate. Thus, in the above example, a first visual cue is generated and presented to speaker S2 to indicate the player P1 is open for communication with speaker S2 and a distinct second visual cue is generated and presented to speaker S3 to indicate the player P1's unwillingness or unavailability to interact with speaker S3 at the current time.

Referring back to FIG. 2, in some implementations, when the visual cues provided to a speaker indicates that the player P1 is not available to interact with the speaker at the current time when the speaker's request is received, the interactions processing engine 250 may provide an option to the speaker to leave a message to player P1. This option can be provided to the speaker along with the visual cues. When the speaker chooses this option and leaves the message for the player P1, the interactions processing engine 250 detects the verbal message left by the speaker and engages the verbal interactions processor 255 to process the verbal message left by the speaker for the player P1. The processing includes identifying the attributes, formatting the verbal message in a format, and presenting the formatted message at an appropriate time specified by or for the player P1 or defined by the game state of the game the player P1 is engaged in currently. The presentation of the formatted message, in some implementations, may follow the presentation requirement specified by or for the player P1. For example, the player P1 may wish to be informed of any verbal message provided by a particular user (e.g., the player P1 may be a child and the speaker may be a parent of the child). The verbal message may be captured using a microphone or other audio capturing devices available to the speaker and is forwarded to the verbal interactions processor 255 for processing. In some implementations, more than one speaker may wish to interact with the player P1 but player P1 may be immersed in gameplay and may not be available to interact with the speakers at the current time when the requests were received.

In some implementations, an interactions interpreter engine 255a within the verbal interactions processor 255 is engaged to process the verbal message of each speaker to identify different attributes of the spoken content, including a language spoken, tone of the speaker, urgency or criticality level of the message contained within the verbal message (e.g., safety of the player P1, an event in the physical world or an appointment or an event within an interactive application that requires the player P1's action/attention, etc.), length of the message, topic, context of the message content, etc. The attribute conveying urgency (e.g., severity level conveyed in the verbal message) can be used to determine when and in what format the verbal messages have to be delivered to the player P1. The verbal messages from the different speakers and the attributes of the verbal messages are provided as inputs to a message conversion engine 257.

In some implementations, an interruption preference engine 255b may be engaged to understand the preferences of the player P1 so that the verbal message(s) from the speaker(s) can be presented to the player P1 in the format and at a time that is appropriate for the player P1. In some implementations, the interruption preference engine 255b may look at the various attributes to determine what the message is conveying (e.g., a critical or severe warning, information, critique of the gameplay, etc.), so that appropriate actions to properly format the messages can be taken prior to presenting the messages to player P1. The preferences of player P1 may specify if, how, when and which speakers'messages have to be presented and the interruption preference engine 255b takes into consideration the identified preferences and the severity level conveyed in the verbal message to the message conversion engine 257.

For example, if the verbal message of speaker S2 has a severe or safety warning to the player P1, then the verbal message of speaker S2 is converted to textual message and formatted to show the severity/safety warning and presented to the player P1 alongside the game content as soon as the verbal message is received. If, on the other hand, the verbal message is informative, then the textual message may have to be formatted differently and presented to the player P1 at a time that is convenient for interrupting the gameplay of player P1. In addition to the aforementioned details, in some implementations, the interruption preference engine 255b may determine the mode of operation of the player P1 and temporal attributes of the gameplay of the video game. The temporal attributes of the gameplay is determined by querying game content and obtaining details of the activity in a portion of the game that the player P1 is currently involved in, the game state in the portion that can be used to identify an amount of activity completed and an amount of remaining activity left to complete, time taken to complete the amount of activity and the time needed to complete the amount of remaining activity, etc., to determine temporal attributes related to the gameplay of the player P1. The temporal attributes of gameplay and the attributes of the verbal messages are used to determine when the player should be interrupted and in what format the verbal messages have to be presented to the player P1. For example, the temporal attributes of gameplay can suggest that the player has only about 20% of an intense or critical activity (e.g., a Boss fight or in a middle of escaping from confines of a place or an adversary) left to complete and, at the current pace of gameplay, the player is expected to complete the activity in about 20 seconds, and the attributes of the verbal messages can suggest that the verbal message contains non-urgent, informative content and, therefore, can be presented after a passage of a predefined amount of time (e.g., after a fixed time period). Based on the various attributes, the message can be scheduled to be presented to the player P1 on a message board/user interface rendered alongside the game content after the 20 seconds have elapsed. Alternately, the temporal attributes can suggest that the player has completed about 75% of the activity and the player is expected to complete the activity in about 25 seconds, and the attributes of the verbal message can suggest that the verbal message contains a very urgent reminder for the player P1. Based on these attributes, the verbal message may have to be converted to textual message and presented to the player P1 immediately. The various attributes associated with the messages from different speakers are provided to the message conversion engine 257 along with the messages for formatting and scheduling so that appropriately formatted messages are presented to the player P1 at a time that is appropriate for the player P1 to consume.

The message conversion engine 257 receives as inputs the messages, the attributes of the messages, and identities of the speakers from the interactions interpreter engine 255a and the preferences of the player P1 from interruption preference engine 255b, and processes these inputs. In some implementations, as part of processing the inputs, the message conversion engine 257 can receive the priorities of the speakers from the speaker prioritizer 256a and uses the priorities of the speakers to determine how the messages have to be presented—i.e., which ones of the speakers'messages have to be prioritized, what language, what format, and when they should be presented to the player P1. The message conversion engine 257 engages a text generator 257a to convert the verbal message to a textual message so as to be able to present the message to the player P1 on the display screen of the HMD 102. The text generator 257a, in turn, can employ a large language module (LLM) 257b to convert the verbal message to a textual message in a preferred or desired language of the player P1 (if the verbal message of a speaker is in a different language) and/or to adjust the linguistic characteristic of the textual message so that it conveys the correct sentiment and can be understood by the player P1. The preferred language of the player P1 may be obtained from the preferences specified in a user profile of the player P1.

In some implementations, instead of converting the verbal message of the speaker to textual message, the message conversion engine 257 can engage a video generator 257c to convert the verbal message to a video. In some implementations, the video may be generated as an animated video, wherein the characters may be used to provide the expressions conveyed in the verbal message of the speaker. The type of video generated is not restricted to the animated video but other types of videos can also be generated to convey the sentiment and other attributes provided in the verbal message. In some implementations, the player P1's preference may suggest the generation of the video to convey the content included in the verbal message. The generated video conveying the sentiment and other attributes of the verbal message can then be presented to the player P1 when it is appropriate to do so.

In some implementations, the verbal message of a speaker may pertain to game context in a portion of the video game that the player is currently playing and may include observations made by the speaker, suggestions for providing the inputs, input sequences that are shown to provide successful result in the portion, etc. In such implementations, the message conversion engine 257, in addition to converting the message to textual format, can also include a link to a video recording of gameplay of the player P1 in the portion of the game that the verbal message is pertaining to in the textual message. The video recording for the portion can be tagged using temporal attributes of the portion of the video game. Depending on the user (i.e., a user who wants to have verbal interaction with the player P1 and is also referred to herein as “a speaker”) providing the interaction or the content included in the message, the player can select to view a replay of the portion of the video game in conjunction with the comments (i.e., interactions) provided by the user. The textual portion of the video game can provide some detail on what moves (i.e., type and sequence of inputs) could help in successfully accomplishing a task in the portion, comments on the gameplay of the player, etc. The player can replay the video of the portion and use the textual content to understand what the user is saying about the gameplay.

In some implementations, the verbal interactions processor 255 may be used to identify the speaker(s) who have expressed interest in interacting with the player P1 as the player P1 is engaged in gameplay of the game and provide visual cues with details of the speaker(s) to the player P1. As the player P1 is immersed in gameplay of the game using the HMD, the player P1 may not be aware of the speakers who are interested in interacting with the player P1. For example, an experienced player P1 fully immersed in playing the video game (or simply referred to as “game”) may be approached by one or more speakers. These speakers may be approaching the player P1 to understand the nuances of the game and to learn some tips and tricks to play the game, for example. The verbal interactions processor 255 may detect the mode of operation of the player P1, detect the requests from one or more speakers for interacting with the player, and generate visual cues for presenting to the player P1. The visual cues, in some implementations, can be in the form of textual content or color-coded textual content, for example, wherein each color can be associated with a distinct speaker and be based on the social relationship of the speaker with the player P1. The visual cues to the player P1 are not restricted to the aforementioned form but can include any other form that can be deciphered by the player P1. The visual cues with the identity of the one or more speakers are provided for rendering on a user interface alongside the game content of the game that the player P1 is playing. In addition to providing the visual cues, one or more options may also be provided to the player P1 to allow them to accept the interaction request from the speaker and converse with the speaker or to ignore the request.

FIGS. 3C-3E illustrate some examples of the information summary provided by the verbal interactions processor 255 to the player P1. FIG. 3C illustrates an example of the informational message presented to the player P1 alongside the game content informing the player P1 that speaker S1 is trying to interact with them. Along with the informational message of speaker S1, an option may also be provided to the player P1 requesting them if they want to accept the request and allow the speaker S1 to interact with the player P1 or not. Depending on the player P1's selection of the option, the verbal interactions processor 255 can allow or deny the Speaker S1's request.

FIG. 3D illustrates another example in which the verbal interactions processor 255 may detect requests from a plurality of speakers trying to interact with the player P1 and summarize the identity of the speakers in a list for presenting to the player P1, in one implementation. The list includes both the real-world speakers and the speakers who are approaching the player P1 online (i.e., digital) world and are presented in the order the requests are received. FIG. 3E illustrates yet another example which is a variation of what is shown in FIG. 3D. In FIG. 3E, the list of speakers who are requesting to interact with the player P1 are prioritized in accordance to the player P1's preference of the speakers and presented in the list in accordance to the order of priority, in an alternate implementation.

The various implementations described herein thus allows an interactions processing engine 250 to obtain or determine a mode of operation of the player P1 as they are engaged in gameplay of a game and provide appropriate visual cues to users who want to interact with the player P1 during their gameplay. The speakers who are approaching the player P1 do not have the visibility of what the player P1 is doing on their HMD and the visual cues ensure that the speakers are informed and not ignored. Further, the summary provided to the player P1 during the gameplay allow the player P1 to see who all are approaching them for interaction and options to make informed decisions of whether to interact with a speaker or not (i.e., continue playing the game). It also provides the ability for the player P1 to view or listen to the interaction of the different speakers at a later time, provide the speakers with the ability to leave messages that can be presented to the player P1 after a delayed start or after lapse of a predefined period of time or immediately. In some implementations, the predefined period of time specified by or for the player P1 may be stored in a time window 299 and referred when determining the time for presenting the interaction of one or more of the speakers. For example, the predefined period of time In some implementation, depending on the game context, the predefined period of time may be dynamically adjusted. In alternate implementations, the pr

As the player P1 continues to interact with the video game and provides additional inputs, the game content and, as a result, game context and game state of the game are dynamically updated, and depending on the intensity of gameplay of the game currently occurring, the mode of operation of the player P1 can be adjusted. The various implementations provides the freedom to the player P1 to decide who they want to interact with and when and the knowledge of the player's status to the speakers so that they can decide on whether they want to wait to talk to the player or leave the message to the player. As the player P1 progresses in the game and the game context and game state change. For example, the mode of operation of the player P1, determined by the mode prediction engine 254, can switch from an isolation mode (i.e., full immersion mode) to interruption mode (e.g., non-immersion or partial immersion mode) and vice versa, and the interactions processing engine 250 detects such switching in the mode of operation and provides appropriate visual cues to the speakers and summary to the player.

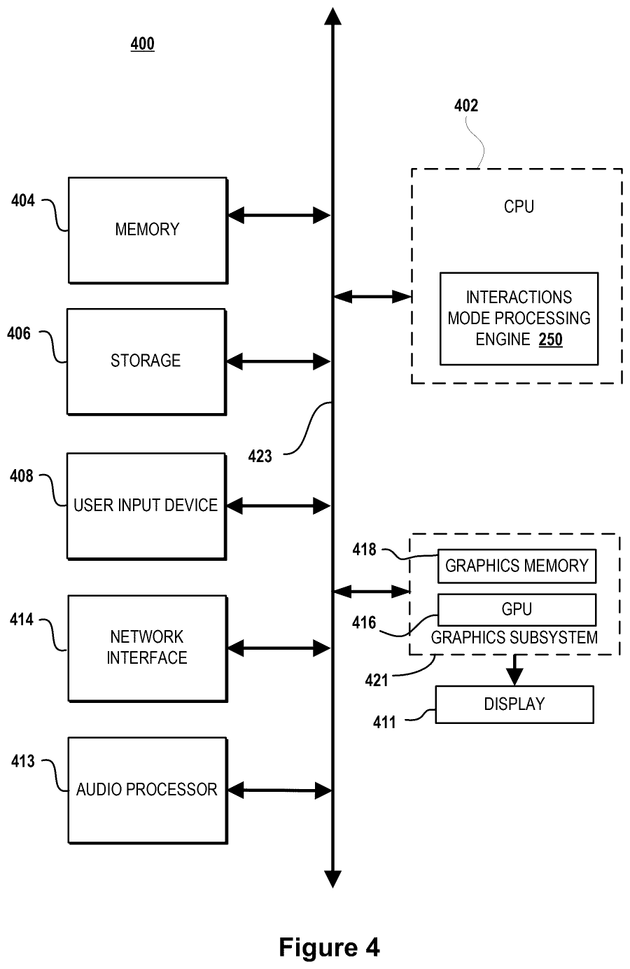

FIG. 4 illustrates components of an example device 400 (e.g., server device within cloud game network 200 of FIG. 1) that can be used to perform aspects of the various embodiments of the present disclosure. This block diagram illustrates a device 400 that can incorporate or can be a personal computer, video game console, personal digital assistant, a server or other digital device, suitable for practicing an embodiment of the disclosure. Device 400 includes a central processing unit (CPU) 402 for running software applications and optionally an operating system. CPU 402 may be comprised of one or more homogeneous or heterogeneous processing cores. For example, CPU 402 is one or more general-purpose microprocessors having one or more processing cores. Further embodiments can be implemented using one or more CPUs with microprocessor architectures specifically adapted for highly parallel and computationally intensive applications, such as processing operations of interpreting a query, identifying contextually relevant resources, and implementing and rendering the contextually relevant resources in a video game immediately. Device 400 may be a localized to a player playing a game segment (e.g., game console), or remote from the player (e.g., back-end server processor), or one of many servers using virtualization in a game cloud system for remote streaming of gameplay to clients.

Memory 404 stores applications and data for use by the CPU 402. Storage 406 provides non-volatile storage and other computer readable media for applications and data and may include fixed disk drives, removable disk drives, flash memory devices, and CD-ROM, DVD-ROM, Blu-ray, HD-DVD, or other optical storage devices, as well as signal transmission and storage media. User input devices 408 communicate user inputs from one or more users to device 400, examples of which may include keyboards, mice, joysticks, touch pads, touch screens, still or video recorders/cameras, tracking devices for recognizing gestures, and/or microphones. Network interface 414 allows device 400 to communicate with other computer systems via an electronic communications network, and may include wired or wireless communication over local area networks and wide area networks such as the internet. An audio processor 413 is adapted to generate analog or digital audio output from instructions and/or data provided by the CPU 402, memory 404, and/or storage 406. The components of device 400, including CPU 402, memory 404, (data) storage 406, user input devices 408, network interface 414, and audio processor 413 are connected via one or more data buses 423.

A graphics subsystem 421 is further connected with data bus 423 and the components of the device 400. The graphics subsystem 421 includes a graphics processing unit (GPU) 416 and graphics memory 418. Graphics memory 418 includes a display memory (e.g., a frame buffer) used for storing pixel data for each pixel of an output image. Graphics memory 418 can be integrated in the same device as GPU 416, connected as a separate device with GPU 416, and/or implemented within memory 404. Pixel data can be provided to graphics memory 418 directly from the CPU 402. Alternatively, CPU 402 provides the GPU 416 with data and/or instructions defining the desired output images, from which the GPU 416 generates the pixel data of one or more output images. The data and/or instructions defining the desired output images can be stored in memory 404 and/or graphics memory 418. In an embodiment, the GPU 416 includes 3D rendering capabilities for generating pixel data for output images from instructions and data defining the geometry, lighting, shading, texturing, motion, and/or camera parameters for a scene. The GPU 416 can further include one or more programmable execution units capable of executing shader programs.

The graphics subsystem 421 periodically outputs pixel data for an image from graphics memory 418 to be displayed on display device 411 (e.g., display device 111 of FIG. 2). Display device 411 can be any device capable of displaying visual information in response to a signal from the device 400, including CRT, LCD, plasma, and OLED displays. Device 400 can provide the display device 411 with an analog or digital signal, for example.

It should be noted, that access services, such as providing access to games of the current embodiments, delivered over a wide geographical area often use cloud computing. Cloud computing is a style of computing in which dynamically scalable and often virtualized resources are provided as a service over the Internet. Users do not need to be an expert in the technology infrastructure in the “cloud” that supports them. Cloud computing can be divided into different services, such as Infrastructure as a Service (IaaS), Platform as a Service (PaaS), and Software as a Service (SaaS). Cloud computing services often provide common applications, such as video games, online that are accessed from a web browser, while the software and data are stored on the servers in the cloud. The term cloud is used as a metaphor for the Internet, based on how the Internet is depicted in computer network diagrams and is an abstraction for the complex infrastructure it conceals.

A game server may be used to perform the operations of the durational information platform for video game players, in some embodiments. Most video games played over the Internet operate via a connection to the game server. Typically, games use a dedicated server application that collects data from players and distributes it to other players. In other embodiments, the video game may be executed by a distributed game engine. In these embodiments, the distributed game engine may be executed on a plurality of processing entities (PEs) such that each PE executes a functional segment of a given game engine that the video game runs on. Each processing entity is seen by the game engine as simply a compute node. Game engines typically perform an array of functionally diverse operations to execute a video game application along with additional services that a user experiences. For example, game engines implement game logic, perform game calculations, physics, geometry transformations, rendering, lighting, shading, audio, as well as additional in-game or game-related services. Additional services may include, for example, messaging, social utilities, audio communication, game play replay functions, help function, etc. While game engines may sometimes be executed on an operating system virtualized by a hypervisor of a particular server, in other embodiments, the game engine itself is distributed among a plurality of processing entities, each of which may reside on different server units of a data center.

According to this embodiment, the respective processing entities for performing the operations may be a server unit, a virtual machine, or a container, depending on the needs of each game engine segment. For example, if a game engine segment is responsible for camera transformations, that particular game engine segment may be provisioned with a virtual machine associated with a graphics processing unit (GPU) since it will be doing a large number of relatively simple mathematical operations (e.g., matrix transformations). Other game engine segments that require fewer but more complex operations may be provisioned with a processing entity associated with one or more higher power central processing units (CPUs).

By distributing the game engine, the game engine is provided with elastic computing properties that are not bound by the capabilities of a physical server unit. Instead, the game engine, when needed, is provisioned with more or fewer compute nodes to meet the demands of the video game. From the perspective of the video game and a video game player, the game engine being distributed across multiple compute nodes is indistinguishable from a non-distributed game engine executed on a single processing entity, because a game engine manager or supervisor distributes the workload and integrates the results seamlessly to provide video game output components for the end user.

Users access the remote services with client devices, which include at least a CPU, a display and I/O. The client device can be a PC, a mobile phone, a netbook, a PDA, etc. In one embodiment, the network executing on the game server recognizes the type of device used by the client and adjusts the communication method employed. In other cases, client devices use a standard communications method, such as html, to access the application on the game server over the internet. It should be appreciated that a given video game or gaming application may be developed for a specific platform and a specific associated controller device. However, when such a game is made available via a game cloud system as presented herein, the user may be accessing the video game with a different controller device. For example, a game might have been developed for a game console and its associated controller, whereas the user might be accessing a cloud-based version of the game from a personal computer utilizing a keyboard and mouse. In such a scenario, the input parameter configuration can define a mapping from inputs which can be generated by the user's available controller device (in this case, a keyboard and mouse) to inputs which are acceptable for the execution of the video game.

In another example, a user may access the cloud gaming system via a tablet computing device, a touchscreen smartphone, or other touchscreen driven device. In this case, the client device and the controller device are integrated together in the same device, with inputs being provided by way of detected touchscreen inputs/gestures. For such a device, the input parameter configuration may define particular touchscreen inputs corresponding to game inputs for the video game. For example, buttons, a directional pad, or other types of input elements might be displayed or overlaid during running of the video game to indicate locations on the touchscreen that the user can touch to generate a game input. Gestures such as swipes in particular directions or specific touch motions may also be detected as game inputs. In one embodiment, a tutorial can be provided to the user indicating how to provide input via the touchscreen for gameplay, e.g., prior to beginning gameplay of the video game, so as to acclimate the user to the operation of the controls on the touchscreen.

In some embodiments, the client device serves as the connection point for a controller device. That is, the controller device communicates via a wireless or wired connection with the client device to transmit inputs from the controller device to the client device. The client device may in turn process these inputs and then transmit input data to the cloud game server via a network (e.g., accessed via a local networking device such as a router). However, in other embodiments, the controller can itself be a networked device, with the ability to communicate inputs directly via the network to the cloud game server, without being required to communicate such inputs through the client device first. For example, the controller might connect to a local networking device (such as the aforementioned router) to send to and receive data from the cloud game server. Thus, while the client device may still be required to receive video output from the cloud-based video game and render it on a local display, input latency can be reduced by allowing the controller to send inputs directly over the network to the cloud game server, bypassing the client device.

In one embodiment, a networked controller and client device can be configured to send certain types of inputs directly from the controller to the cloud game server, and other types of inputs via the client device. For example, inputs whose detection does not depend on any additional hardware or processing apart from the controller itself can be sent directly from the controller to the cloud game server via the network, bypassing the client device. Such inputs may include button inputs, joystick inputs, embedded motion detection inputs (e.g., accelerometer, magnetometer, gyroscope), etc. However, inputs that utilize additional hardware or require processing by the client device can be sent by the client device to the cloud game server. These might include captured video or audio from the game environment that may be processed by the client device before sending to the cloud game server. Additionally, inputs from motion detection hardware of the controller might be processed by the client device in conjunction with captured video to detect the position and motion of the controller, which would subsequently be communicated by the client device to the cloud game server. It should be appreciated that the controller device in accordance with various embodiments may also receive data (e.g., feedback data) from the client device or directly from the cloud gaming server.

In one embodiment, the various technical examples can be implemented using a virtual environment via a head-mounted display (HMD). An HMD may also be referred to as a virtual reality (VR) headset. As used herein, the term “virtual reality” (VR) generally refers to user interaction with a virtual space/environment that involves viewing the virtual space through an HMD (or VR headset) in a manner that is responsive in real-time to the movements of the HMD (as controlled by the user) to provide the sensation to the user of being in the virtual space or metaverse. For example, the user may see a three-dimensional (3D) view of the virtual space when facing in a given direction, and when the user turns to a side and thereby turns the HMD likewise, then the view to that side in the virtual space is rendered on the HMD. An HMD can be worn in a manner similar to glasses, goggles, or a helmet, and is configured to display a video game or other metaverse content to the user. The HMD can provide a very immersive experience to the user by virtue of its provision of display mechanisms in close proximity to the user's eyes. Thus, the HMD can provide display regions to each of the user's eyes which occupy large portions or even the entirety of the field of view of the user, and may also provide viewing with three-dimensional depth and perspective.

In one embodiment, the HMD may include a gaze tracking camera that is configured to capture images of the eyes of the user while the user interacts with the VR scenes. The gaze information captured by the gaze tracking camera(s) may include information related to the gaze direction of the user and the specific virtual objects and content items in the VR scene that the user is focused on or is interested in interacting with. Accordingly, based on the gaze direction of the user, the system may detect specific virtual objects and content items that may be of potential focus to the user where the user has an interest in interacting and engaging with, e.g., game characters, game objects, game items, etc.

In some embodiments, the HMD may include an externally facing camera(s) that is configured to capture images of the real-world space of the user such as the body movements of the user and any real-world objects that may be located in the real-world space. In some embodiments, the images captured by the externally facing camera can be analyzed to determine the location/orientation of the real-world objects relative to the HMD. Using the known location/orientation of the HMD the real-world objects, and inertial sensor data from the, the gestures and movements of the user can be continuously monitored and tracked during the user's interaction with the VR scenes. For example, while interacting with the scenes in the game, the user may make various gestures such as pointing and walking toward a particular content item in the scene. In one embodiment, the gestures can be tracked and processed by the system to generate a prediction of interaction with the particular content item in the game scene. In some embodiments, machine learning may be used to facilitate or assist in said prediction. During HMD use, various kinds of single-handed, as well as two-handed controllers can be used. In some implementations, the controllers themselves can be tracked by tracking lights included in the controllers, or tracking of shapes, sensors, and inertial data associated with the controllers. Using these various types of controllers, or even simply hand gestures that are made and captured by one or more cameras, it is possible to interface, control, maneuver, interact with, and participate in the virtual reality environment or metaverse rendered on an HMD. In some cases, the HMD can be wirelessly connected to a cloud computing and gaming system over a network. In one embodiment, the cloud computing and gaming system maintains and executes the video game being played by the user. In some embodiments, the cloud computing and gaming system is configured to receive inputs from the HMD and the interface objects over the network. The cloud computing and gaming system is configured to process the inputs to affect the game state of the executing video game. The output from the executing video game, such as video data, audio data, and haptic feedback data, is transmitted to the HMD and the interface objects. In other implementations, the HMD may communicate with the cloud computing and gaming system wirelessly through alternative mechanisms or channels such as a cellular network.

Additionally, though implementations in the present disclosure may be described with reference to a head-mounted display, it will be appreciated that in other implementations, non-head mounted displays may be substituted, including without limitation, portable device screens (e.g. tablet, smartphone, laptop, etc.) or any other type of display that can be configured to render video and/or provide for display of an interactive scene or virtual environment in accordance with the present implementations. It should be understood that the various embodiments defined herein may be combined or assembled into specific implementations using the various features disclosed herein. Thus, the examples provided are just some possible examples, without limitation to the various implementations that are possible by combining the various elements to define many more implementations. In some examples, some implementations may include fewer elements, without departing from the spirit of the disclosed or equivalent implementations.

Embodiments of the present disclosure may be practiced with various computer system configurations including hand-held devices, microprocessor systems, microprocessor-based or programmable consumer electronics, minicomputers, mainframe computers and the like. Embodiments of the present disclosure can also be practiced in distributed computing environments where tasks are performed by remote processing devices that are linked through a wire-based or wireless network.

Although the method operations were described in a specific order, it should be understood that other housekeeping operations may be performed in between operations, or operations may be adjusted so that they occur at slightly different times or may be distributed in a system which allows the occurrence of the processing operations at various intervals associated with the processing, as long as the processing of the telemetry and game state data for generating modified game states and are performed in the desired way.

One or more embodiments can also be fabricated as computer readable code on a computer readable medium. The computer readable medium is any data storage device that can store data, which can be thereafter be read by a computer system. Examples of the computer readable medium include hard drives, network attached storage (NAS), read-only memory, random-access memory, CD-ROMs, CD-Rs, CD-RWs, magnetic tapes and other optical and non-optical data storage devices. The computer readable medium can include computer readable tangible medium distributed over a network-coupled computer system so that the computer readable code is stored and executed in a distributed fashion.

In one embodiment, the video game is executed either locally on a gaming machine, a personal computer, or on a server. In some cases, the video game is executed by one or more servers of a data center. When the video game is executed, some instances of the video game may be a simulation of the video game. For example, the video game may be executed by an environment or server that generates a simulation of the video game. The simulation, on some embodiments, is an instance of the video game. In other embodiments, the simulation maybe produced by an emulator. In either case, if the video game is represented as a simulation, that simulation is capable of being executed to render interactive content that can be interactively streamed, executed, and/or controlled by user input.

Although the foregoing embodiments have been described in some detail for purposes of clarity of understanding, it will be apparent that certain changes and modifications can be practiced within the scope of the appended claims. Accordingly, the present embodiments are to be considered as illustrative and not restrictive, and the embodiments are not to be limited to the details given herein, but may be modified within the scope and equivalents of the appended claims.

1. A method, comprising:
detecting a speaker attempting to interact with a player engaged in gameplay of a video game via a head mounted display (HMD) at a current time;
analyzing inputs provided by the player at the current time to determine a level of involvement of the player in the gameplay; and
providing visual cues to the speaker to indicate the level of involvement of the player in the video game at the current time and an option to interrupt the player during gameplay, the visual cues indicative of a likelihood of interruption entertained by the player at the current time of gameplay of the video game,
wherein operations of the method are performed by an interactions processing engine executing on a server computing device.

2. The method of claim 1, wherein the level of involvement of the player is used to determine a mode of operation defined for the gameplay, the mode of operation indicative of the likelihood of interruption entertained by the player at the current time of the gameplay.

3. The method of claim 2, wherein the mode of operation for specifying includes one of an isolation mode and an interruption mode,
wherein the isolation mode is selected to indicate full immersion of the player in the gameplay and the interruption mode is selected to indicate a partial immersion or non-immersion of the player in the gameplay and the player is willing to entertain interruption.

4. The method of claim 2, wherein analyzing the inputs further includes,
analyzing game content generated by applying the inputs provided by the player to the video game, the game content including information to determine game context and game state at the current time; and
using the game state and the game context of gameplay and the inputs provided by the player determine the level of involvement of the player in the gameplay at the current time, the level of involvement used to determine the likelihood of interruption entertained by the player during the current time of gameplay, and the option to interrupt the player provided by the interactions processing engine to the speaker based on the game context and the game state.

5. The method of claim 4, wherein the level of involvement and the mode of operation of the player and the option to interrupt the player are updated dynamically to correspond with changes detected in the game context and the game state as the player continues gameplay of the video game.

6. The method of claim 4, wherein defining the mode of operation includes,
querying game logic of the video game to obtain an intensity of the gameplay in a portion of the video game the player is interacting in at the current time, the intensity of the gameplay defining a degree of concentration required from the player during the gameplay in the portion, wherein the degree of concentration required and the inputs provided by the player are used to determine the level of involvement of the player in the gameplay.

7. The method of claim 6, wherein the intensity of the gameplay is directly proportional to the degree of concentration required from the player.

8. The method of claim 6, wherein determining the level of involvement includes,
analyzing the inputs provided by the player in the portion of the video game in accordance to the intensity of the gameplay required in said portion to define the level of involvement exhibited by the player in said portion of the video game.

9. The method of claim 6, wherein when the intensity of the gameplay in the portion indicates a slow phase in the gameplay, the mode of operation of the player is dynamically set to interruption mode and the visual cues and the option provided to the speaker are adjusted to correspond with the interruption mode to indicate that the player can be interrupted at the current time of gameplay.

10. The method of claim 9, further includes pausing the gameplay of the portion of the video game, the pausing of the gameplay initiated by the interaction processing engine to allow the speaker to interact with the player.

11. The method of claim 9, further includes dynamically adjusting one or more characteristics associated with the gameplay of the video game, so as to allow the player to interact with the speaker, the dynamic adjustment includes reducing at least one of speed and volume.

12. The method of claim 6, wherein when the intensity of the gameplay in the portion indicates an intense phase in the gameplay, setting the mode of operation of the player to an isolation mode and the visual cues and the option provided to the speaker are updated to correspond with the isolation mode to indicate that the player is fully immersed in the gameplay at the current time.

13. The method of claim 12, wherein the option provided to the speaker is updated to allow the speaker to leave a verbal message to the player, and
wherein, responsive to detecting the verbal message from the speaker, converting the verbal message to a format specified for the player to derive a formatted message, and forwarding the formatted message for rendering to the player in accordance to a presentation requirement specified for the player.

14. The method of claim 13, wherein the format can be one of a textual format, video format, anime format, and a temporally delayed audio format, and
wherein the presentation requirement specifies one of a time and a location on a display screen for presenting the formatted message, and
wherein the time and the format are defined based on severity of content included in the verbal message.

15. The method of claim 1, wherein the speaker is a real-world person approaching the player in a physical world or a spectator following the gameplay of the player and approaching the player online.

16. The method of claim 15, wherein when the speaker is the real-world person, the visual cues are presented on an outside surface of the HMD of the player, and when the speaker is the spectator approaching the player online, providing the visual cues on a screen of the speaker alongside the game content generated during gameplay of the video game by the player.

17. The method of claim 1, wherein the visual cues provided for the speaker are speaker-specific and defined based on a social relationship of the speaker to the player.

18. A method, comprising:
detecting a speaker attempting to interact with a player engaged in gameplay of a video game via a head mounted display (HMD) at a current time;
applying inputs provided by the player during gameplay of the video game to generate game content, the game content providing information used to determine game context and a game state of the video game at the current time;
analyzing the game context and the game state of the video game to determine a level of involvement of the player in the gameplay at a current time; and
when the level of involvement of the player indicates that the player is fully immersed in the gameplay, providing visual cues to the player, the visual cues providing details of the speaker attempting to interact with the player during gameplay,
wherein operations are performed by an interactions processing engine executing on a server.

19. The method of claim 18, wherein the details included in the visual cues include at least an identity of the speaker, a type and content of interaction initiated by the speaker.

20. The method of claim 19, wherein when more than one speaker expresses interest in interacting with the player during gameplay, the details included in the visual cues include a list of speakers that have expressed interest in interacting with the player and content of the interactions, and
wherein the list of speakers is prioritized in accordance to a preference of the speakers specified for the player.

21. The method of claim 19, wherein determining the level of involvement further includes,
determining a mode of operation specified for the gameplay of the player, the mode of operation used to determine if the player allows interruption during gameplay.

22. The method of claim 21, wherein the mode of operation is provided by the player or is determined by analyzing game logic of the video game and the inputs provided during gameplay of the player.

23. The method of claim 21, when the mode of operation specified for the gameplay of the player indicates an isolation mode, providing the visual cues includes,
receiving an audio message from the speaker that corresponds to a portion of the video game the player is engaged in at the current time; and
converting the audio message into textual content for rendering on a screen of the player alongside the game content.

24. The method of claim 23, wherein converting the audio message further includes providing a link to access a video recording of the portion of the video game capturing the gameplay of the player at the current time within the textual content, the video recording tagged with temporal attributes of the portion of the video game, the access allowing the player to watch a replay of the portion of the gameplay and the textual content is rendered alongside the video, and
wherein the audio message pertains to gameplay of the player in the portion of the video game.

25. The method of claim 19, further includes,
receiving additional inputs from the player as the player continues with the gameplay; and
updating the game content of the video game by applying the additional inputs received from the player, the updating of the game content resulting in updates to the game context and the game state of the video game,
wherein the level of involvement of the player is adjusted to correlate with changes detected in the game context and the game state, the adjustment to the level of involvement influencing the mode of operation of the player.
